(19) United States
(12) Patent Application Publication
(10) Pub. No.: US 2011/0016428 A1
(43) Pub. Date: Jan. 20, 2011

(54) NESTED SCROLLING SYSTEM

(75) Inventors: Fred William Lupton, III, Saline, MI (US); Tuhin Diptiman, Ann Arbor, MI (US); Charan Singh Lota, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/503,875

(22) Filed: Jul. 16, 2009

(51) Int. Cl. G06F 3/048; G06F 3/033; G06F 17/30

(52) U.S. Cl. 715/830; 345/184; 707/E17.009

(57) ABSTRACT

A nested scrolling system that can scroll through an electronically stored list is provided. The system can include a database, a display screen, a first scrolling control and a second scrolling control. The database can have an electronically stored list with a plurality of entries, the plurality of entries stored under a first level storage category and/or a second level storage category. The second scrolling control can be nested within the first scrolling control with movement of the first scrolling control scrolling through the plurality of entries on a micro level and movement of the second scrolling control scrolling through the plurality of entries on a macro level.

### FIELD OF THE INVENTION

The present invention is related to a scrolling system, and in particular, a nested rotary scrolling system.

### BACKGROUND OF THE INVENTION

As electronic devices become smaller and more affordable, the use of multimedia systems continues to increase. Such multimedia systems can become relatively complex and can include radio modules, audio modules, navigation modules, cellular telephone modules and the like. Despite the complexity of such a multimedia system, it is desirable that the modules be easy to use in order so that, for example, a driver of a motor vehicle is not distracted while attempting to use or operate the radio, cell phone and the like.

One aspect or feature of a module can be a list of items to be scanned or scrolled through. Such lists can include a contacts list used for calling someone with a cell phone, a music list for playing on a stereo, a list of geographic locations for a GPS module to provide instructions and the like. In addition, such lists can become relatively long as multiple entries are added over time, a long list requiring additional time to scan or scroll through when searching for a particular item or listing. Therefore, a system that reduces the time to retrieve an individual item or listing from a list would be desirable.

### SUMMARY OF THE INVENTION

A nested scrolling system that can scroll through an electronically stored list is provided. The system can include a database that has an electronically stored list with a plurality of entries, the plurality of entries stored under a first level storage category and/or a second level storage category. In one alternative, the database can have a tree structure with one or more levels, and each item in a level can have one or more treed levels below it. In another alternative, the plurality of entries can be stored on three or more level storage categories or stored using only a single level storage category.

The system can also include a first scrolling control and a second scrolling control. The first scrolling control can be nested within the second scrolling control, or in the alternative, the second scrolling control can be nested within the first scrolling control. The first and/or second scrolling control can be in the form of a rotary knob, a switch, lever, electronic touch-screen control and the like. In addition, the first scrolling control and the second scrolling control can be in communication with the database. A display screen can also be provided, the display screen being in communication with the database and operable to display at least part of the plurality of entries.

Movement of the first scrolling control can afford scrolling through the plurality of entries on a micro level and movement of the second scrolling control can afford scrolling through the plurality of entries on a macro level. In some instances, movement of the first scrolling control in a first direction scrolls through the plurality of entries on the micro level in a first order and movement of the control in a second direction scrolls through the plurality of entries in a reverse order. The micro level can be an individual listing of the plurality of entries, with at least part of the plurality of entries displayed on the display screen.

Similarly, movement of the second scrolling control in a first direction scrolls through the plurality of entries on the macro level in a first order and movement in a second direction scrolls through the plurality of entries in a reverse order. The macro level can be a set of characters, the set of characters being a set of alphabetical characters, a set of numeric characters, a set of alphanumeric characters and the like.

For example and for illustrative purposes only, the plurality of entries can be a list of names of individuals, a list of names of musical recordings, a list of names of geographical locations and the like. The list of names can be scrolled through individually, i.e. on the micro level, and/or scrolled through by alphabetical characters alone, i.e. on the macro level, until a desired name is displayed on the display screen and optionally selected.

### BRIEF DESCRIPTION OF THE DRAWINGS

FIG. 1 is a schematic circuit diagram of an embodiment of the present invention; and

FIG. 2 is a schematic illustration of a display screen displaying at least part of a plurality of entries storage category according to an embodiment of the present invention.

### DETAILED DESCRIPTION OF THE INVENTION

The present invention discloses a nested scrolling system for scrolling through an electronically stored list. As such, the present invention has utility as a component for a machine, electronic device, etc.

The nested scrolling system can include a database that can have a first level storage category and a second level storage category that can be nested within the first level storage category. In one alternative, the database can have a tree structure with one or more levels, and each item in a level can have one or more treed levels below it. In another alternative, the plurality of entries can be stored on three or more level storage categories or stored using only a single level storage category. The database can also have an electronically stored list with a plurality of entries, the plurality of entries being stored under one or more storage categories in an organized configuration.

A first scrolling control and a second scrolling control nested within the first scrolling control can also be included, as well as a display screen. The first scrolling control and the second scrolling control can be in communication with the database. The display screen can also be in communication with the database and be operable to display at least part of the plurality of entries. Movement of the first scrolling control can scroll through the plurality of entries on a micro level and movement of the second scrolling control can scroll through the plurality of entries on a macro level.

The micro level can be an individual listing of the plurality of entries stored in an organized configuration. For example and for illustrative purposes only, the plurality of entries can be a list of names such as a list of individuals, a list of musical recordings, a list of geographical locations, a list of businesses and the like. It is appreciated that the list of names in the form of the plurality of entries can also include contact information such as telephone numbers, street addresses, email addresses, etc. In addition, the list of names of musical recordings can include the name of a singer of a song, a band or orchestra that performed a musical recording and the like. As such, the list of names can be scrolled through alphabetically on the display screen when the first scrolling control is engaged and moved. In particular, movement of the first scrolling control in a first direction can scroll through the plurality of entries in a first order and movement of the first scrolling control in a second direction can scroll through the plurality of entries in a reverse order relative to the first order.

The macro level can be a set of characters, for example and for illustrative purposes only, a set of alphabetical characters, a set of numeric characters, a set of alphanumeric characters and the like. In some instances, the macro level is a set of alphabetical characters with at least a subset of the alphabetical characters displayed on the display screen alphabetically when the first scrolling control is engaged. In addition, the set of alphabetical characters can be scrolled through alphabetically on the display screen when the second scrolling control is engaged and moved. In particular, movement of the second scrolling control in a first direction can scroll through the set of alphabetical characters in a first order and movement of the second scrolling control in a second direction can scroll through the set of alphabetical characters in a reverse order relative to the first order.

The list of names can be displayed on the display screen alphabetically when the first and/or second scrolling control knob is engaged. It is appreciated that the list of names can be stored alphabetically under appropriate alphabetical characters such that movement of the second scrolling control scrolls through the alphabetical characters until reaching a character of a desired name. In the alternative, the list of names are not stored under appropriate alphabetical characters, but can still be scrolled through on the micro level and/or the macro level. Once a desired alphabetical character is displayed on the display screen, for example by moving the second scrolling control, the first scrolling control can be used to scroll through the individual list of names until a desired name is displayed on the display screen and optionally selected.

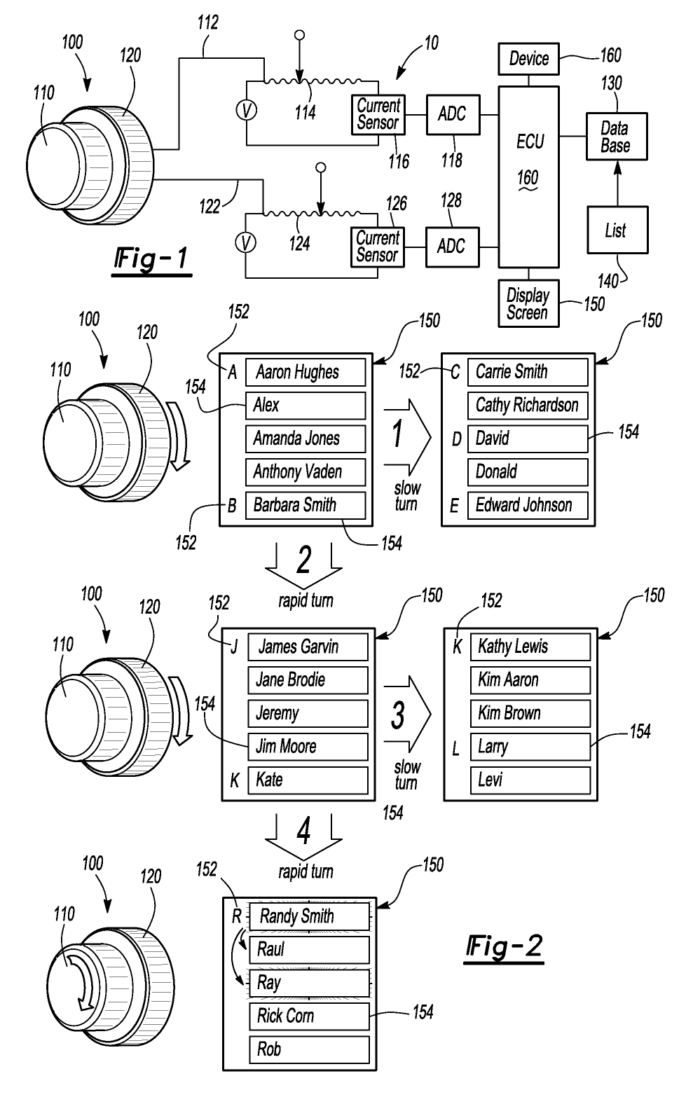

Turning now to FIG. 1, an electrical circuit according to an illustrative embodiment of a nested scrolling system is shown generally at 10. The system 10 can include a pair of nested scrolling controls 100 that include a first scrolling control 110 and a second scrolling control 120. For the purposes of the present invention, the term “nested scrolling controls” is defined as an assemblage of controls that are located or set proximate each other. In some instances, the first scrolling control 110 and the second scrolling control 120 can be in the form of rotary knobs as shown in the figures, however this is not required. For example, the first and/or second scrolling control can be in the form of a switch, lever, electronic touch-screen control and the like, so long as one of the scrolling controls is nested with respect to and/or within the other scrolling control.

The first scrolling control 110 can have an electrical lead 112 that leads to a potentiometer 114. Movement, e.g. rotation or turning, of the first scrolling control 110 can change the effective length of a resistor that is part of the potentiometer 114 and thereby change the current passing therethrough. The change in current can be detected by a current sensor 116, resulting in an analog signal being transmitted to an analog to digital converter (ADC) 118. The ADC 118 can convert the analog signal from the current sensor 116 to a digital signal and transmit the digital signal to an electronic control unit (ECU) 160.

In communication with the ECU 160 can be a database 130, a display screen 150 and a device 160. The database 130 can have a list 140 with a plurality of entries electronically stored therewithin. For the purposes of the present invention, the term communication includes electrical communication and wireless communication. The digital signal received by the ECU 160 can be processed and used to determine when and at what rate to scroll through the list 140 within the database 130. The list 140 can be stored in an organized configuration under a first level storage category and/or a second level storage category, and include a list of names, numbers, pictures, diagrams and the like. In the alternative, the database 130 can have only a single level storage category, three or more level storage categories and/or a tree structure where each item in a given level can have one or more treed levels below it. If the database 130 has a first and second level storage category, the first level storage category can be a set of characters, for example a set of alphabetical characters, a set of numeric characters, a set of alphanumeric characters and the like. As such, the system 10 affords for scrolling through the list 140 in a systematic manner at a first level using the first scrolling control 110. In the alternative, the system 10 affords for scrolling through the list 140 on a micro level using the first scrolling control 110.

Movement of the second scrolling control 120 can change the length of a resistor that is part of a potentiometer 124, thereby changing the current sensed at current sensor 126. An analog signal from the current sensor 126 can be transmitted to an ADC 128 which thereby provides a digital signal to the ECU 160. Upon receiving the digital signal from the ADC 128, the ECU 160 can process the signal and determine how much and at what rate to scroll through the list 140 scroll on a macro level. It is appreciated that as the ECU 160 scrolls through the list 140, or at least part of the list 140, the list can be displayed on the display screen 150. Furthermore, once an individual listing, name, item, etc., of the list 140 is selected, it can be used by the device 160.

For example and for illustrative purposes only, if the list is a list of names for musical recordings, the second scrolling control 120 can be turned or rotated until an alphabetical letter under which a name of a desired song is stored, is displayed on the display screen 150. Thereafter, the first scrolling control 110 can be turned or rotated until the desired song is highlighted, displayed, etc., and the song can be selected and played on the device 160, e.g. an audio device.

In the alternative, the list 140 can be in the form of a telephone directory with names stored alphabetically under alphabetical characters. As such, the second scrolling control 120 can be turned or rotated until an alphabetical letter under which a desired name is stored, is displayed on the display screen 150. Thereafter, the first scrolling control 110 can be turned or rotated until the desired name is highlighted, displayed, etc., the name selected and a phone number associated with the name dialed using the device 160, e.g. a cellular telephone. In this manner, the list 140 can be scrolled through on a macro level and/or micro level.

Turning now to FIG. 2, illustrative schematic drawings of the display screen 150 and the pair of nested scrolling controls 100 are shown. The display screen 150 can display a first and/or macro level 152 and a second and/or micro level 154. In this particular example, the first and/or macro level 152 is a set of alphabetical characters and the second and/or micro level 154 is a set of names displayed alphabetically.

Looking particular to the actions indicated by the arrows on the first scrolling control 110 and the second scrolling control 120, and looking at the arrows labeled 1, 2, 3 and 4, examples of an embodiment of the present invention are illustrated. Arrow 1 illustrates how a slow turn or rotation of the second scrolling control 120 scrolls through the second and/or macro level 152 in a step-by-step fashion such that the alphabetical characters are displayed sequentially on the display screen 150. It is appreciated that turning the second scrolling control 120 in a first direction scrolls through the second and/or macro level 152 in a first order, e.g. an ascending order, while turning the second scrolling control 120 in a second direction scrolls through the second and/or macro level in a reverse order, e.g. descending. In this manner, all of the characters of a second and/or macro level can be scrolled through and shown on the display screen 150.

Looking specifically at arrow 2, a result of a rapid turn of the second scrolling control 120 is illustrated. In this instance, the second and/or macro level 152 displayed on the display screen 150 changes or jumps from alphabetical characters A-B to J-K. As such, a fast turn of the second scrolling control 120 can quickly scroll through the second and/or macro level 152 without displaying all of the characters. As such, it is appreciated that a rapid movement of one of the scrolling controls can afford a predetermined jump through the plurality of entries in order to accelerate movement therethrough. The accelerated jump can be a jump by a preset number of items or individual listings, a preset number of characters, a preset percentage of the plurality of entries, a dynamic number that is a function of the size of the electronically stored list, the rate of movement of the scrolling control, combinations thereof and the like.

Arrow 3 illustrates that returning to a slow turn of the second scrolling control 120 results in sequential display of the second and/or macro level 152. With respect to arrow 4, a rapid turn of the second scrolling control 120 again results in rapidly scrolling through the second and/or macro level 152, as illustrated by the display screen 150 changing the characters displayed from J-K to R. In addition, the individual entries under the second and/or macro level 152 can be shown and rotation of the first scrolling control 110 can scroll through the first and/or micro level 154 one entry, item, listing, etc. at a time.

For example and for illustrative purposes only, an individual can be looking for the name Ray, the name Ray representing an individual to be contacted, the name of a song, the name of a musical performer and the like. Once the name Ray has been highlighted on the display screen 150 using the second scrolling control 120 and/or first scrolling control 110, the name can be selected, for example by pushing upon the first scrolling control 110. Once the desired name is selected, it can be used by a device, module, etc., to call a person and/or company, play a musical recording, show directions to a geographical location and the like.

In this manner, a list can be rapidly scrolled through such that an individual name, entry, listing, etc. can be selected in a relatively short amount of time. In addition, the nested scrolling system affords for search of numeric listings in a similar manner. For example and for illustrative purposes only, a telephone book listing electronically stored in database 130 can be scrolled through using an ascending or descending listing of the telephone numbers, thereby allowing an individual to search or look up a telephone number appearing on an incoming call to a cell phone, and thus find a name associated with the incoming phone call. As such, an individual operating a machine, e.g. a motor vehicle will spend a minimum amount of time scrolling through a list and thus decrease the likelihood of being distracted.

The foregoing drawings, discussion and description are illustrative of specific embodiments of the present invention, but they are not meant to be limitations upon the practice thereof. In addition, the schematic electronic circuit shown in FIG. 1 is for illustrative purposes only and it is appreciated that one skilled in the art would recognize and/or design other electronic circuits that can perform the same functions as disclosed herein. As such, other electronic circuits, display screens and the like fall within the scope of the present invention. As such, numerous modifications and variations of the invention will be readily apparent to those of skill in the art in view of the teaching presented herein. It is the following claims, including all equivalents, which define the scope of the invention.

We claim:

1. A nested scrolling system for scrolling through an electronically stored list, said system comprising:
a database having an electronically stored list with a plurality of entries;
a first scrolling control and a second scrolling control nested within said first scrolling control, said first scrolling control and said second scrolling control in communication with said database;
a display screen in communication with said database and operable to display at least part of said plurality of entries;
wherein movement of said first scrolling control scrolls through said plurality of entries on a micro level and movement of said second scrolling control scrolls through said plurality of entries on a macro level.

2. The nested scrolling system of claim 1, wherein said micro level is an individual listing of said plurality of entries.

3. The nested scrolling system of claim 1, wherein said macro level is a set of characters, said set of characters selected from the group consisting of a set of alphabetical characters, a set of numeric characters and a set of alphanumeric characters.

4. The nested scrolling system of claim 1, wherein moving said first scrolling control in a first direction scrolls through said plurality of entries on said micro level in a first order and moving said first scrolling control in a second direction scrolls through said plurality of entries in a reverse order from said first order.

5. The nested scrolling system of claim 4, wherein said first order is an ascending order.

6. The nested scrolling system of claim 1, wherein movement of said second scrolling control in a first direction scrolls through said plurality of entries on said macro level in a first order and movement of said second scrolling control in a second direction scrolls through said plurality of entries in a reverse order from said first order.

7. The nested scrolling system of claim 6, wherein said first order is an ascending order.

8. The nested scrolling system of claim 1, wherein said first scrolling control is a first rotary knob and said second scrolling control is a second rotary knob, said first rotary knob nested within said second rotary knob.

9. A nested rotary scrolling system for scrolling through an electronically stored list, said system comprising:
a database having an electronically stored list with a plurality of entries;
a first rotary knob and a second rotary knob nested within said first rotary knob, said first rotary knob and said second rotary knob in communication with said database;
a display screen in communication with said database and operable to display at least part of said plurality of entries;
wherein rotation of said first rotary knob scrolls through said plurality of entries on said display screen on a micro level and rotation of said second rotary knob scrolls through said plurality of entries on said display screen on a macro level.

10. The nested rotary scrolling system of claim 9, wherein said micro level is an individual listing of said plurality of entries on said display screen.

11. The nested rotary scrolling system of claim 9, wherein said macro level is a set of characters, said set of characters selected from the group consisting of a set of alphabetical characters, a set of numeric characters and a set of alphanumeric characters.

12. The nested rotary scrolling system of claim 11, wherein said macro level is a set of alphabetical characters.

13. The nested rotary scrolling system of claim 12, wherein at least a subset of said set of alphabetical characters is displayed on said display screen alphabetically when said second rotary knob is engaged.

14. The nested rotary scrolling system of claim 10, wherein said set of alphabetical characters is scrolled through on said display screen when said second rotary knob is engaged and rotated.

15. The nested rotary scrolling system of claim 14, wherein turning said second rotary knob in a first direction scrolls through said set of alphabetical characters in a first order and turning said second rotary knob in a second direction scrolls through said set of alphabetical characters in a reverse order from said first order.

16. The nested rotary scrolling system of claim 15, wherein said first order is an ascending order.

17. The nested rotary scrolling system of claim 10, wherein at least a subset of said individual listing of said plurality of entries is displayed on said display screen alphabetically when said first rotary knob is engaged.

18. The nested rotary scrolling system of claim 17, wherein said individual listing of said plurality of entries is scrolled through on said display screen alphabetically when said first rotary knob is engaged and rotated.

19. The nested rotary scrolling system of claim 18, wherein turning said first rotary knob in a first direction scrolls through said individual listing of said plurality of entries in a first order and turning said first rotary knob in a second direction scrolls through said individual listing of said plurality of entries in a reverse order from said first order.

20. The nested rotary scrolling system of claim 19, wherein said first order is an ascending order.
